(19) United States
(12) Patent Application Publication
(10) Pub. No.: US 2007/0248532 A1
(43) Pub. Date: Oct. 25, 2007

(54) Fluid treatment

(76) Inventors: Eric John Reardon, Waterloo (CA); Hartwig Peemoeller, Waterloo (CA); Alan George Seech, Mississauga (CA)

Correspondence Address: Paul E. Schaafsma, NovusIP, LLC, Suite 221, 521 West Superior Street, Chicago, IL, 60610-3135, US

(21) Appl. No.: 11/411,346

(22) Filed: Apr. 25, 2006

(51) Int. Cl. C01B 3/08

(52) U.S. Cl. 423/658; 423/648.1

(57) ABSTRACT

In accordance with the principles of the present invention, fluid is treated with MCM-41 amended with a metallic reducing agent. The iron undergoes anaerobic corrosion and produces hydrogen gas. The hydrogen gas is used at the MCM-41 to carry out dehalogenation reactions. The body of metal containing MCM-41 amended with a metallic reducing agent can be much thinner than conventional bodies of metal and therefore easier to install. In one embodiment the treated fluid can be water while in another embodiment the treated fluid can be a gas. A body of metal containing MCM-41 amended with a metallic reducing agent can be placed below the ground surface to treat contaminated groundwater in-situ. For pumped fluid, in one embodiment treatment units as small in size as a water softener can allow for treatment of relatively high flow rates of pumped contaminated fluid.

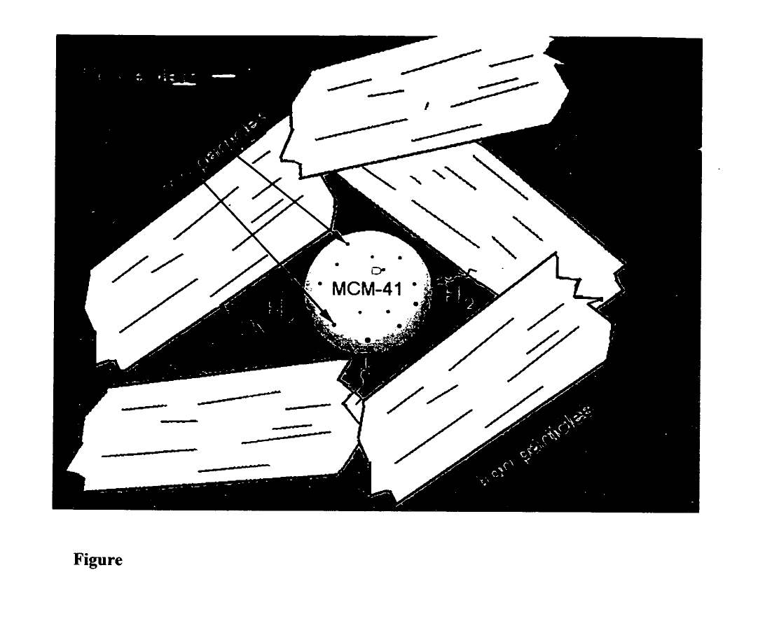

### FIELD OF THE INVENTION

The present invention relates to methods and apparatuses for abiotic/chemical treatment of fluids such as water and gas.

### BACKGROUND OF THE INVENTION

Iron metal has been recognized over the past 10 years as a useful material for facilitating treatment of contaminated fluids. Such fluids subject to treatment can include not just contaminated water, but also polluted gases that are free of oxygen such as for example gases related to contaminated soil; gases emanating from landfills, other waste disposal sites or groundwaters; and gases from industrial processes.

Attempts have been made to plate iron surfaces with more noble metals such as nickel, platinum, and palladium which can improve the iron bimetal dehalogenation reactivity and efficiency. (Wan, C., Chen, Y. H. and Wei, R. “Dechlorination of Chloromethanes on Iron and Palladium-Iron Bimetallic Complexes in Aqueous System,” 18 Env., Tox. & Chem 1091-1096 (1999); Guasp, E. and Wei, R., “Dehalongenation of Trihalommethanes in Drinking Water on Pd—Fe Bimetallic Surface,” 78 J. Chem. Tech. Biotech. 654-658 (2003)). Delays in the application of this technology are related to a rapid loss of the reactivity of the coatings. The reactivity of the material is reduced to that of uncoated material in a matter of days to weeks. The probable causes are removal or deactivation of the plated metal by dissolution or iron oxide/carbonate precipitation on the particle surfaces, respectively. (Lai, G. and Gillham, R. W., “Evaluating the Performance of Palladium-Plated Granular Iron for Reductive Declorination of TCE. Groundwater Quality: Natural and Enhanced Restoration of Groundwater Pollution,” Proceeds of the Groundwater Quality 2001 Conference held at Sheffield, U.K., June 2001, IAHS Publ. no. 275, pp. 403-408 (2001)).

It would therefore be advantageous to minimize the loss of the reactivity of coatings of noble metals such as nickel, platinum, and palladium.

### SUMMARY OF THE INVENTION

A method in accordance with the principles of the present invention improves the reactivity of noble metal-metallic reducing agent combinations. In accordance with the principles of the present invention, fluid is treated with a MCM-41 amended metallic reducing agent such as iron or zinc. The metallic reducing agent undergoes anaerobic corrosion and produces hydrogen gas. The hydrogen gas is used at the MCM-41 pore surface to carry out dehalogenation reactions. The body of metal containing a MCM-41 amended metallic reducing agent can be much thinner than conventional bodies of metal and therefore easier to install in deep contaminated aquifers. In one embodiment, the treated fluid can be water while in another embodiment the treated fluid can be a gas. A body of metal containing a MCM-41 amended metallic reducing agent can be placed below the ground surface to treat contaminated groundwater in-situ. For pumped fluid, in one embodiment treatment units as small in size as a water softener can allow for treatment of relatively high flow rates of pumped contaminated fluid.

### BRIEF DESCRIPTION OF THE DRAWINGS

The Figure is a schematic representation of the dehalogenation performance of a metallic reducing agent in accordance with the principles of the present invention.

### DETAILED DESCRIPTION OF THE PREFERRED EMBODIMENT

In accordance with the principles of the present invention, two reactive materials are combined to enhance degradation of environmental contaminants that are subject to reductive degradation such as organic chemicals including chlorinated hydrocarbons. The first reactive material, Mobil Crystalline Material 41 (MCM-41), is a newly discovered, mesoporous, silicate-based material. The second reactive material is a metallic reducing agent. The present invention is used to degrade environmental contaminants such as for example chlorinated benzenes, trichloroethylene (TCE), tetrachloroethene (PCE), and polychlorinated biphenyls (PCBs) in contaminated fluids, to non-toxic hydrogenated compounds. When used herein the term fluid refers not just to water, but also gases that are free of oxygen such as for example gases related to contaminated soil; gases emanating from landfills, other waste disposal sites or groundwaters; and gases from industrial processes.

Mobil Crystalline Material 41 (MCM-41) was discovered in the early 1990's and is a silica-based, mesoporous solid with zeolitic tunnel-like structures. (Beck, J. S., Vartuli, J. C., Leonowicz, M. E., Kresge, C. T., Schmitt, K. D., Chu, C. T. W., Olsen, D. H., Sheppard, E. W., McCullen, S. B., Higgins, J. B., and Schlenker, J. L., “A New Family of Mesoporous Molecular Sieves Prepared with Liquid Crystal Templates,” 114 J. Am. Chem. Soc. 114, 10834 (1992)). MCM-41 has a two-dimensional structure and surface areas typically larger than about 1000 m²/g. MCM-41 has large pore diameters (about 2 to about 10 nm) and anomalously high surface areas. (Chen, C. Y., Li, H. X. and Davis, M. E., “Studies on Mesoporous Materials I. Synthesis and Characterization of MCM-41,” 2 Micr porous Mater. 17-26 (1993)).

A variety of metals and metal oxides have been implanted into the structure of MCM-41. Acidic catalysts can be generated through solid substitution of trivalent cations such as aluminum (Al), boron (B) or gallium (Ga) into MCM-41. (Janicke, M., Kumar, D., Stucky, G. and Chmelka, B. F., “Aluminum Incorporation in Mesoporous Molecular Sieves,” 84 Stud. Surf Sci. Catal. 84, 243 (1994)). Oxidation/reduction catalysts can be generated by structural implantation of transition metals, such as copper (Cu), molybdenum (Mo), iron (Fe), and vanadium (V). (Cui, J., Yue, Y-H., Sun, Y., Dong, W-Y. and Gao, Z., “Characterization and Reactivity of Ni, Mo-supported MCM-41-Type Catalysts for Hydrodesulferization,” 105 Stud. Surf. Sci. Catal. 687 (1997); Moretti, G., Ferraris, G. and Galli, P., “Autoreduction of Cu²⁺ Species in Cu-ZSM-5 Catalysts—Studies by Diffuse Reflectance Spectroscopy, X-Ray Photoelectron Spectroscopy, Thermogravimetry and Elemental Analysis, 135 Stud. Surf. Sci. Catal. 5020 (2001)).

The accessible pores and channels of MCM-41 can also be used to house large, metalloorganic molecules, such as metallocene, a polymer builder (Maschmeyer, T., Rey, F., Sankar, G. and Thomas, J. M., “Hetrogeneous Catalysts Obtained by Grafting Metallocene Complexes onto Mesoporous Silica,” 378 Nature 159-162 (1995)) or metalloporphrin, an oxidation catalyst. (Sayari, A., “Catalysis by Crystalline Mesoporous Molecular Sieves,” 8 Chem. Mater. 1840 (1996)). The catalytic effect on activity of these molecules can be enhanced within the MCM-41 structure. Recently, Okumara et al. palladized the internal surfaces of MCM-41 particles and documented that catalytic hydrogenation and dehalogenation reactions in organic fluids were carried out in the presence of molecular hydrogen. (Okumara, K., Tokai, H. and Niwa, M., “Structural Analysis of Pd Loaded MCM-41 Catalysts for Hydrogenation of Benzene by means of XAFS,” Photon Factory Activity Report, No. 20, Part B (2003)) Thus, MCM-41 holds promise in the treatment of a variety of environmental contaminants, such as for example chlorinated benzenes, trichloroethylene (TCE), perchloroethylene (PCE) and polychlorinated biphenyls (PCBs).

The present invention improves the performance characteristics of metallic reducing agents by mixing in small quantities of palladized MCM-41 with the metallic reducing agent. The metallic reducing agent undergoes anaerobic corrosion in the presence of moisture and produces hydrogen gas. The hydrogen gas then can be used at palladized sites in the MCM-41 to carry out dehalogenation reactions. Use of the present invention has the potential to improve the efficiency of metallic reducing agents to degrade environmental contaminants and increase the range of potential contaminants that can be treated. The metallic reducing agents can include for example iron or zinc. If iron, powdered or granular iron materials can be utilized. Other noble metals other than palladium such as for example nickel and platinum may be used in the MCM-41 structure.

In accordance with the principles of the present invention, a metallic reducing agent is physically modified to expand the range of treatable organic compounds, improve the reaction kinetics, and perhaps extend the reactive lifetime of the metallic reducing agent. A noble metal component (e.g. palladium) will be separated from the metallic reducing agent by incorporating the noble metal within a high surface area, mesoporous solid (MCM-41). Hydrogen gas will be generated from continual anaerobic corrosion of the iron in the presence of moisture. So in addition to the dehalogenation ability of the metallic reducing agent itself, the hydrogen gas generated from continual anaerobic corrosion of the metallic reducing agent in the presence of moisture, will diffuse to palladized sites within the mesoporous MCM-41 to effect additional dehalogenation reactions. Thus, the addition of palladized MCM-41 has the potential not only to improve the overall dehalogenation efficiency of the metallic reducing agent but also perhaps to facilitate additional and even more recalcitrant reductive degradation reactions.

Referring to the Figure, a schematic of the basic concept of the present invention of the degradation performance of metallic reducing agents is seen. The Figure particularly depicts the degradation performance of powdered or granular iron. Because the specific surface areas of MCM-41 is about 100 times or more greater than the surface area of typical powdered or granular irons, even the addition of one mass percent of MCM-41 to powdered or granular iron would double the available surface area for reaction. The Figure shows that hydrogen gas, which is constantly generated through anaerobic corrosion of powdered or granular iron, diffuses towards a mesoporous MCM-41 particle where the hydrogen gas can catalyze dehalogenation reactions at palladized sites both at the surface and within the particle. Unused hydrogen can be taken up and stored in the lattices of the plated palladium nanoclusters, where the hydrogen may be used in future hydrogenation reactions. It has been shown that palladium (Pd) nanoclusters take on hydrogen (H) to H/Pd atom ratios as high as about 0.9. (Hanneken, J. W., Baker, D. B., Conradi, M. S. and Eastman, J. A., “NMR Study if the Nanocrystalline Palladium-Hydrogen System,” 330-332 J. Alloys and Compounds 714-717 (2002)).

For in-situ applications, the application of the principles of the present invention could consist of a thin reactive body of metal containing MCM-41 amended metallic reducing agent. This thin reactive body of metal containing MCM-41 amended metallic reducing agent could be much thinner than conventional bodies of metal and therefore easier to install in deep contaminated aquifers. In one embodiment, the body of metal containing MCM-41 amended metallic reducing agent can comprise a permeable reactive barrier (PRB) containing MCM-41 amended iron. For pumped groundwater, treatment units similar to a water softener in size could allow treatment of relatively high flow rates of pumped contaminated fluid.

In one embodiment of the present invention, the metallic reducing agent can be iron derived processed scrap materials, thereby providing an inexpensive source of iron that would otherwise contribute to pollution.

While the invention has been described with specific embodiments, other alternatives, modifications and variations will be apparent to those skilled in the art. Accordingly, it will be intended to include all such alternatives, modifications and variations set forth within the spirit and scope of the appended claims.

What is claimed is:

1. A method of treating a fluid comprising combining MCM-41 with a metallic reducing agent whereby the metallic reducing agent undergoes anaerobic corrosion in fluid and produces hydrogen gas and further whereby the hydrogen gas is used at the MCM-41 to carry out dehalogenation reactions.

2. The method of treating a fluid of claim 1 further including mixing palladized MCM-41 with the metallic reducing agent.

3. The method of treating a fluid of claim 2 further including mixing palladized MCM-41 with iron.

4. The method of treating a fluid of claim 3 further including mixing about 0.5 to about 15.0 mass percent of MCM-41 with the iron.

5. The method of treating a fluid of claim 1 further wherein the metallic reducing agent comprises iron.

6. The method of treating a fluid of claim 5 further wherein the iron is a recovery iron derived from processed scrap materials.

7. The method of treating a fluid of claim 1 further including treating water.

8. The method of treating a fluid of claim 1 further including treating gas.

9. A method of treating a fluid comprising combining a silica-based, mesoporous solid with zeolitic tunnel-like structures with a metallic reducing agent whereby the metallic reducing agent undergoes anaerobic corrosion and produces hydrogen gas and further whereby the hydrogen gas is used at the silica-based, mesoporous solid with zeolitic tunnel-like structures to carry out dehalogenation reactions.

10. The method of treating a fluid of claim 9 further including mixing palladized silica-based, mesoporous solid with zeolitic tunnel-like structures with the metallic reducing agent.

11. The method of treating a fluid of claim 10 further including mixing about one mass percent of palladized silica-based, mesoporous solid with zeolitic tunnel-like structures with the metallic reducing agent.

12. The method of treating a fluid of claim 9 further wherein the metallic reducing agent comprises iron.

13. The method of treating a fluid of claim 12 further wherein the iron is recovery iron derived from processed scrap materials.

14. The method of treating a fluid of claim 9 further including treating water.

15. The method of treating a fluid of claim 9 further including treating gas.

16. A method of treating a fluid comprising combining a two-dimensional structure having surface areas typically larger than about 1000 m²/g and pore diameters of about 2 to about 10 nm with a metallic reducing agent whereby the metallic reducing agent undergoes anaerobic corrosion and produces hydrogen gas and further whereby the hydrogen gas is used at the two-dimensional structure having surface areas typically larger than about 1000 m²/g and pore diameters of about 2 to about 10 nm to carry out dehalogenation reactions.

17. The method of treating a fluid of claim 16 further including mixing palladized two-dimensional structure having surface areas typically larger than about 1000 m²/g and pore diameters of about 2 to about 10 nm with the metallic reducing agent.

18. The method of treating a fluid of claim 17 further including mixing about one mass percent of palladized two-dimensional structure having surface areas typically larger than about 1000 m²/g and pore diameters of about 2 to about 10 nm with the metallic reducing agent.

19. The method of treating a fluid of claim 16 further wherein the metallic reducing agent comprises iron.

20. The method of treating a fluid of claim 19 further wherein the iron is recovery iron derived from processed scrap materials.

21. The method of treating a fluid of claim 16 further including treating water.

22. The method of treating a fluid of claim 16 further including treating gas.

23. A method of treating a fluid comprising combining MCM-41 with a metallic reducing agent whereby a noble metal component is separated from the metallic reducing agent and the metallic reducing agent undergoes anaerobic corrosion and produces hydrogen gas and further whereby the hydrogen gas is used at the MCM-41 to carry out dehalogenation reactions.

24. The method of treating a fluid of claim 23 further including mixing palladized MCM-41 with the metallic reducing agent.

25. The method of treating a fluid of claim 24 further including mixing about 0.5 to about 15.0 mass percent of MCM-41 with the metallic reducing agent.

26. The method of treating a fluid of claim 23 further wherein the metallic reducing agent comprises iron.

27. The method of treating a fluid of claim 26 further wherein the iron comprises recovery iron derived from processed scrap materials.

28. The method of treating a fluid of claim 23 further including treating water.

29. The method of treating a fluid of claim 23 further including treating gas.

30. A method of treating a fluid comprising applying a body of metal containing MCM-41 amended with a metallic reducing agent.

31. The method of treating a fluid of claim 30 further including applying a body of metal containing about 0.5 to about 15.0 mass percent of MCM-41 with metallic reducing agent.

32. The method of treating a fluid of claim 30 further including applying a body of metal placed below the ground surface containing MCM-41 amended with metallic reducing agent, to treat contaminated groundwater in-situ.

33. The method of treating a fluid of claim 32 further including applying a permeable reactive barrier placed below the ground surface containing MCM-41 amended with metallic reducing agent, to treat contaminated groundwater in-situ.

34. The method of treating a fluid of claim 30 further including providing a body of metal containing MCM-41 amended with metallic reducing agent, and pumping the fluid to the body of metal.

35. The method of treating a fluid of claim 30 further wherein the metallic reducing agent comprises iron.

36. The method of treating a fluid of claim 35 further wherein the iron is recovery iron derived from processed scrap materials.

37. The method of treating a fluid of claim 30 further including treating gas.
